(19) United States
(12) Patent Application Publication
(10) Pub. No.: US 2004/0203267 A1
(43) Pub. Date: Oct. 14, 2004

(54) Self-alignment structure

(76) Inventors: Ching-Shih Chen, Taipei (TW); Che-Hung Huang, Jungli City (TW)

Correspondence Address: J.C. Patents, Inc., Suite 250, 4 Venture, Irvine, CA, 92618, US

(21) Appl. No.: 10/621,051

(22) Filed: Jul. 15, 2003

(30) Foreign Application Priority Data
Apr. 14, 2003 (TW) 92205769

(51) Int. Cl. F16G 11/00

(52) U.S. Cl. 439/76.1; 403/13

(57) ABSTRACT

A self-alignment structure inside a cradle set for accommodating a personal digital assistant (PDA) module is provided. The cradle set has a circuit board (206) and a connector (204) therein. The alignment structure comprises a base plate (208), at least a sectional bolt (210) and an elastic body (220). The base plate has at least a threaded hole (208a). The sectional bolt has a cap piece (216) at the top end and a threaded section (212) at the bottom end. The threaded section of the sectional bolt passes through the circuit board and screwed into the threaded hole in the base plate so that the circuit board and the base plate are locked together. In addition, there is a space between the sectional bolt and the circuit board for accommodating the elastic body. The ends of the elastic body are in contact with the surface of the circuit board and the bottom surface of the cap piece respectively so that any stress resulting from a misalignment between the connector of the PDA module the connector in the cradle set is buffered by the elastic body.

### CROSS-REFERENCE TO RELATED APPLICATION

This application claims the priority benefit of Taiwan application serial no. 92205769, filed Apr. 14, 2003.

### BACKGROUND OF THE INVENTION

1. Field of Invention

The present invention relates to an attachment structure for a connector. More particularly, the present invention relates to a self-alignment connector structure within a cradle set for accommodating a personal digital assistant (PDA) module.

2. Description of Related Art

Personal digital assistant (PDA) is a convenient portable tool for organizing personal activities. The original concept behind the design of a PDA is to provide a user with a multi-purpose electronic (digital) notebook capable of managing traveling schedules, recording events and registering incoming communication. Due to the increase in operating speed of computers, the ease of Internet connection and wireless communication, most PDA is able to initiate wireless communication, connect to a network, play games or start multi-media activities. Hence, the PDA is often regarded as a palm-top computer.

In general, a PDA has many built-in connectors serving many functions including, for example, a power connector, an input/output (I/O) connector or an external card connector. The power connector is normally set up at the bottom end of the PDA. To charge up a PDA, the power connector (a female connector) of the PDA is inserted into a corresponding connector (a male connector) within a cradle set for charging. The I/O connector is also positioned at the bottom end of the PDA. When the PDA needs to hook up with a computer to transfer data, the I/O connector (a female connector) of the PDA is inserted into a corresponding I/O connector (a male connector) within a cradle set. The connector inside the cradle set is usually attached to a circuit board with the circuit board fastened to the base of the cradle set through a screw.

FIG. 1 is a schematic cross-sectional view of a conventional mounting structure for a cradle set connector. To ensure the connector 20 (a female connector) at the bottom end of a PDA module 10 and the connector 104 (a male connector) at a cradle set 100 are firmly engaged together, the cradle set 100 is built with various elements. As shown in FIG. 1, the cradle set 100 comprises a plug-in groove 102, a connector 104, a circuit board 106 and a base plate 108. The plug-in groove 102 is an area for accommodating the bottom end of the PDA module 10. The connector 104 protrudes from the bottom of the plug-in groove and fits snugly with the connector 20 on the PDA module 10. The circuit board 106 is firmly attached to the base plate 108 by means of a screw 110. Note that the plug-in groove 102 has an arc-shaped interior to match the shape at the bottom end of the PDA module 10. Furthermore, when the PDA module 10 is resting inside the plug-in groove 102, the back surface 12 of the PDA module 10 is backed against a slant interior sidewall of the plug-in groove 102. In addition, the connector 104 is fixed in a vertical direction relative to the circuit board 106. Since the PDA module 10 is backed against the sidewall of the plug-in groove 102 at a definite angle, the connector 104 inside the plug-in groove 102 is also oriented at the same angle.

When the PDA module 10 is mounted in the cradle set 100 with the connector 10 engaging with the connector 20, some stress occurs to the connector 20. The stress results from some alignment error between the two connectors 20 and 104. In particular, since the PDA module 10 normally has an overall rigidness level much greater than the cradle set, and the PDA module 10 sits on the cradle set 100, most of the stress generated by the alignment error between the two connectors 20, 104 usually is subjected to connector 104 within the cradle set 100, rather than the connector 20 inside the PDA module 10. Consequently, an over-concentration of stress on the connector 104 within the cradle set 100 will likely occur.

Furthermore, if a user unplugging the PDA module 10 from the plug-in groove 102 does not pull the module 10 up in the prescribed direction, that is, pulling to one side before lifting the module 10, the connector 104 may bend or deform. In some cases, the connection between the connector 104 and the circuit board 106 may even be broken. Ultimately, reliability of the connection with the connector 104 will be compromised.

### SUMMARY OF THE INVENTION

Accordingly, one object of the present invention is to provide a self-alignment structure in a cradle set for accommodating a personal digital assistant (PDA) module such that the stress between the PDA module and a latching connector in the cradle set is buffered.

A second object of this invention is to provide a self-alignment structure in a cradle set for accommodating a personal digital assistant (PDA) that can increase the reliability of alignment with a fixed connector structure.

To achieve these and other advantages and in accordance with the purpose of the invention, as embodied and broadly described herein, the invention provides a self-alignment structure in a cradle set for accommodating a PDA module. The cradle set for the PDA comprises a circuit board and a connector. The connector is fixed on the circuit board. The self-alignment structure has a base plate, at least a sectional bolt and an elastic body. The base plate has a screw hole and the threaded end of the sectional bolt passes through the circuit board and locked onto the screw hole in the base plate. The sectional surface of the sectional bolt is at a distance from the surface of the circuit board to accommodate the elastic body. Hence, the elastic body is in contact with both the sectional surface of the sectional bolt and the surface of the circuit board so that the stress when the PDA module latches onto the connector of the cradle set is buffered.

According to one embodiment of this invention, the elastic body can be a spring washer or compression spring with a through hole in the middle. The two surfaces on each side of the spring washer or the compression spring are in contact with the surface of the circuit board and the sectional surface of the sectional bolt. In another embodiment of this invention, the elastic body can be a rubber washer having a through hole in the middle. The two surfaces of the rubber washer are in contact with the surface of the circuit board and the sectional surface of the sectional bolt. In addition, the outer sidewall of the through hole can have a spacer in the gap between the circuit board and the sectional bolt. In yet another embodiment of this invention, the rubber washer can have a through hole and an outer groove ring. The inner surface of the outer groove ring is in contact with a second surface of the circuit board and the outer sidewall of the through hole has a spacer in the gap between the circuit board and the sectional bolt.

This invention employed a self-alignment structure to buffer the stress when the connective terminal of the PDA module latches with the connector in the cradle set. Hence, the stress resulting from misalignment between the PDA module and the fixed connector structure in the cradle set is buffered through the elastic body. In other words, the deformation of the elastic body is able to provide a proper alignment tolerance between the PDA module and the fixed connector structure within the cradle set.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic cross-sectional view of a conventional mounting structure for a PDA module and a cradle set connector.

FIG. 2 is a schematic cross-sectional view of a mounting structure for a PDA module and a cradle set connector according to a first embodiment of this invention.

FIG. 3A is a magnified view of a circled portion of the mounting structure in FIG. 2.

FIG. 3B is a magnified view of a portion of the mounting structure in accordance with a second embodiment of the present invention.

FIGS. 4 to 8 are magnified views respectively showing a portion of five mounting structures in accordance with five further different embodiments of the present invention.

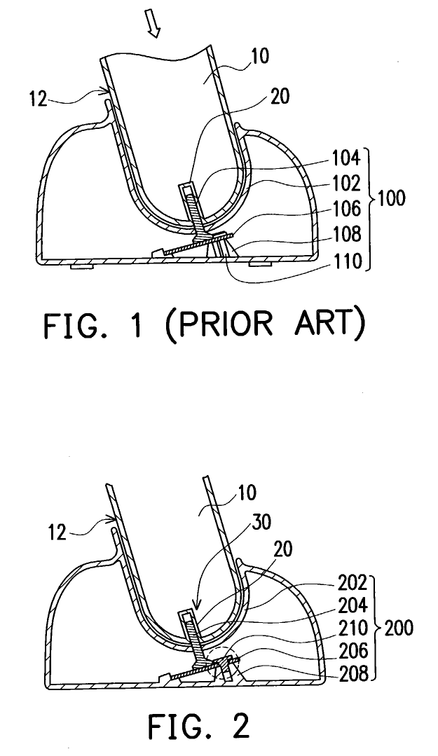

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a schematic cross-sectional view of a self-alignment structure according to a first embodiment of this invention. As shown in FIG. 2, the self-alignment structure within a connector cradle set 200 is designed to accommodate a personal digital assistant (PDA) module 10. The bottom end of the PDA module 10 has a connective terminal 30. The connective terminal 30 has a built-in connector 20 (a female connector) for engaging with a corresponding connector 204 (a male connector) in the cradle set 200. Although a PDA module 10 is used to illustrate the embodiment of this invention, the connective terminal of other devices having a function similar to a PDA including, for example, mobile phones, smart phones or other portable electronic device can also use the self-alignment structure.

As shown in FIG. 2, the connector cradle set 200 comprises a plug-in groove 202, a connector 204, a circuit board 206, a base plate 208 and a sectional bolt 210. The plug-in groove 202 is the area for accommodating the connective terminal 30 of the PDA module 10. The plug-in groove 202 has an arc-shaped interior surface to match the shape at the bottom end of the PDA module 10. Furthermore, when the PDA module 10 is resting inside the plug-in groove 202, the back surface 12 of the PDA module 10 is backed against a slant interior sidewall of the plug-in groove 202. In addition, one end of the connector 204 protrudes from the bottom of the plug-in groove 202 to engage snugly with connector 20 of the connective terminal 30 of the PDA module 10. Since the PDA module 10 is backed against the sidewall of the plug-in groove 202 at a definite angle, the connector 204 also protrudes from the plug-in groove 202 at the same angle.

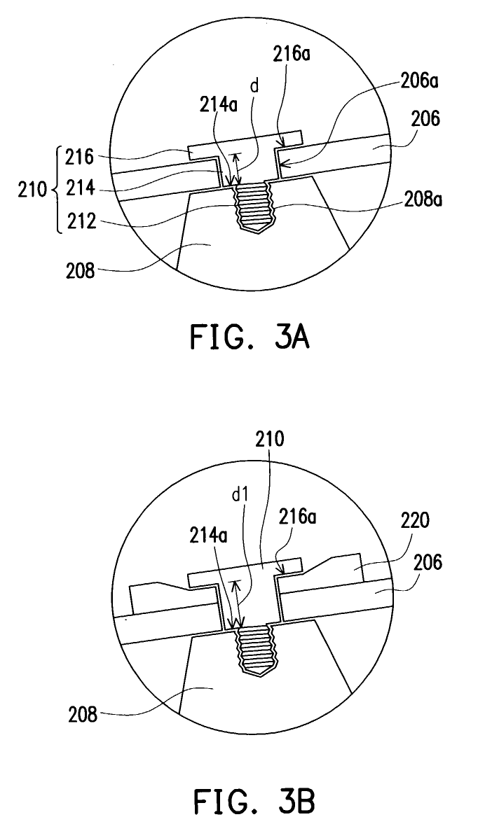

Note that the connector 204 is vertically positioned over the circuit board 206. To ensure the circuit board 206 is attached to the base plate 208, the circuit board 206 is locked onto the base plate 208 using the sectional bolt 210. FIG. 3A is a magnified view of a circled portion in FIG. 2. The base plate 208 has a screw hole 208a and the sectional bolt 210 has a corresponding screw terminal 212 (the threaded section of the sectional bolt 210). The threaded section 212 of the sectional bolt 210 passes through the positioning hole 206a in the circuit board 206 and screws into he screw hole 208a in the base plate 208. In addition, the sectional bolt 210 also has a rod body 214 having a bottom surface connected to the threaded section 212 and a top surface connected to a cap piece 216. The rod body 214 has a diameter greater than the threaded section 212. The bottom surface of the rod body 214 has a first sectional surface 214a engaging an upper surface of the base plate 208. The bottom surface of the cap piece 216 has a second sectional surface 216a facing an upper surface of the circuit board 206. Furthermore, the first sectional surface 214a and the second sectional surface 216a are separated from each other by a distance d. Therefore, the circuit board 206 with a thickness slightly smaller than d can be accommodated between the two sectional surfaces 214a and 216a. In other words, the rod body 214 has a length which is larger than the thickness of the circuit board 206. The circuit board 206 is not tightly gripped through the sectional bolt 210 due to dimensional tolerance between the set distance d and thickness of the circuit board. With such dimensional tolerance, alignment tolerance between the PDA module 10 and the connector 204 in the cradle set 200 is increased.

FIG. 3B is a magnified view of a portion of a mounting structure (self-alignment structure) in accordance with a second embodiment of the present invention. In this embodiment, the distance d1 (with d1>d) between the first sectional surface 214a and the second sectional surface 216a of the sectional bolt 210 is large enough even to accommodate an elastic body 220. The two surfaces of the elastic body 220 are in contact with the surface of the circuit board 206 and the second sectional surface 216a of the sectional bolt 210 respectively to buffer any stress resulting from alignment error between the connector 20 of the PDA module 10 and the connector 204 of the cradle set 200. Since the mounting structure of the connector 204 uses a sectional bolt 210, the alignment tolerance between the two connectors 20 and 204 are increased. Moreover, with the deployment of the elastic body 220, any stress resulting from misaligning the connectors 20 and 204 is buffered. Hence, aside from providing some stress buffering capability, this invention also increases the alignment tolerance over the conventional connector mounting structure.

In the following, a few types of elastic body are described with reference to appropriate diagrams. However, the illustrations below by no means limit the material makeup, the shape or the thickness of the elastic body. Any modification according to the scope of this invention should still be regarded as within the spirit of this invention.

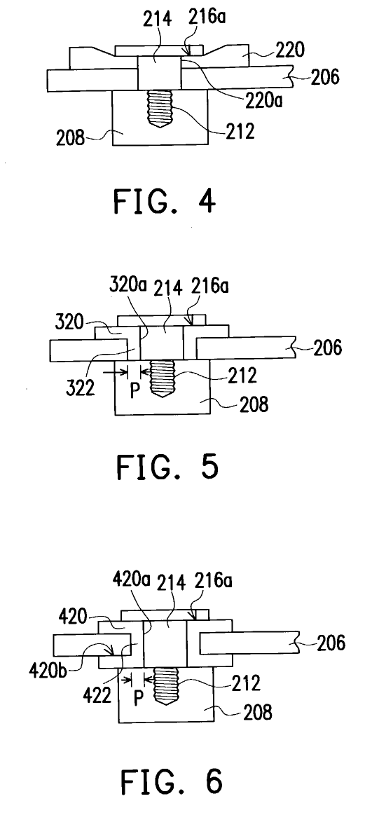

FIG. 4 is a diagram showing a first type of elastic body assembly according to this invention. The elastic body can be a compressed spring washer or a rubber washer 220, for example. The washer 220 has a through hole 220a for accommodating the rod body 214 of the sectional bolt 210. The upper surface and the lower surface of the washer 220 are in contact with the second sectional surface 216a of the sectional bolt 210 and the surface of the circuit board 206 respectively. In the assembling process, the threaded section 212 of the sectional bolt 210 passes through the through hole 220a of the washer 220 and the through hole in the circuit board 206 and then screws into the screw hole 212 in the base plate 208.

FIG. 5 is a diagram showing a second type of elastic body assembly according to this invention. The elastic body is a rubber washer 320 having a through hole 320a for accommodating the rod body 214 of the sectional bolt 210. In addition, the rubber washer 320 has a spacer 322 attached to the lower surface of the washer 320 that occupies the gap p between the circuit board 206 and the rod body 214 of the sectional bolt 210. The upper and the lower surface of the rubber washer 320 are in contact with the second sectional surface 216a of the sectional bolt 210 and the surface of the circuit board 206 respectively. In the assembling process, the threaded section 212 of the sectional bolt 210 passes through the through hole 320a of the washer 320 and then screws into the screw hole 212 in the base plate 208.

FIG. 6 is a diagram showing a third type of elastic body assembly according to this invention. The elastic body is a rubber washer 420 having a through hole 420a for accommodating the rod body 214 of the sectional bolt 210. Furthermore, the side surface of the washer 420 also has an outer groove ring 420b. The inner surfaces of the outer groove ring 420b are in contact with the respective surfaces of the circuit board 406. In addition, there is a spacer 422 between the outer groove ring 420b and the through hole 420a and in the gap p between the circuit board 206 and the rod body 214 of the sectional bolt 210. The upper and the lower surfaces of the rubber washer 420 are in contact with the second sectional surface 216a of the sectional bolt 210 and the surface of the base plate 208 respectively. In the assembling process, the threaded section 212 of the sectional bolt 210 passes through the through hole 420a of the washer 420 and then screws into the screw hole 208a in the base plate 208.

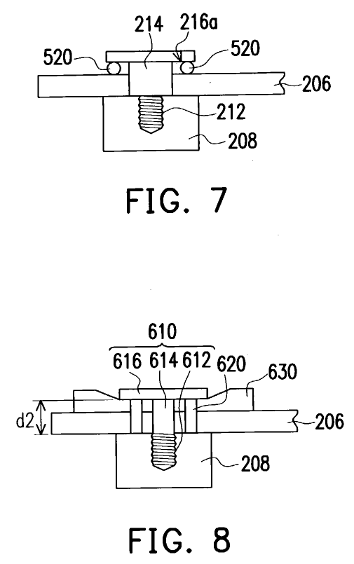

FIG. 7 is a diagram showing a fourth type of elastic body assembly according to this invention. The elastic body is a compressed spring 520, for example. The two ends of the spring 520 are in contact with the circuit board 206 and the second sectional surface 216a of the sectional bolt 210 respectively. In addition, the elastic body can also be a spiraling spring having a function similar to the compression spring. In the assembling process, the threaded section 212 of the sectional bolt 210 passes through the through hole 420a of the washer 420 and the through hole in the circuit board 206 and then screws into the screw hole 208a in the base plate 208.

FIG. 8 is a schematic cross-sectional view of a self-alignment structure according to a still further embodiment of this invention. Aside from using the sectional bolt to increase alignment tolerance as in the first embodiment, a long bolt 610 and a spacer ring 620 can be deployed to provide the circuit board 206 together with the connector 204 with a certain degree of alignment tolerance. The long bolt 610 has a threaded section 612 but the rod body 614 has a diameter similar to the threaded section 612. The spacer ring 620 has a thickness d2 so that the circuit board 206 with a thickness d can be accommodated (d2>d). Similarly, the contact area between the spacer ring 620 and the base plate 208 is defined as a first sectional surface and the contact area between the spacer ring 620 and a cap piece 616 on top of the long bolt 610 is defined as a second sectional surface. Hence, the circuit board 206 is not tightly gripped within the gap formed by the long bolt 610 and the spacer ring 620 due to alignment tolerance. With such dimensional tolerance, alignment tolerance between connector 20 of the PDA module 10 and the connector 204 in the cradle set 200 is increased.

Similarly, this embodiment also permits the incorporation of an elastic body 630 within the alignment structure. The types of assemblies are similar to the ones outlined in the previous embodiments according to FIGS. 4 to 7. With the installation of the elastic body 630 within the structure, the stress due to the misalignment between the connector 20 of the PDA module 10 and the connector 204 is buffered.

In summary, the self-alignment structure inside a cradle set is suitable for mounting a PDA module. The cradle set comprises a circuit board and a connector mounted on the circuit board. The self-alignment structure has a base plate, at least a sectional bolt and an elastic body. The base plate has a threaded hole. The threaded section of the sectional bolt passes through the circuit board and screws tightly to the threaded hole in the base plate. In addition, there is a space between the sectional bolt and the circuit board for accommodating an elastic body. The two surfaces of the elastic body are in contact with the surface of the circuit board and the sectional surface of the sectional bolt so that any stress generated due to misalignment between the connector of the PDA module and the corresponding connector on the cradle set is buffered.

Therefore, the self-alignment structure of this invention has the following advantages:

1. Through the elastic body, the mounting structure of the connector has the capacity to buffer the stress when the PDA module engages with the connector in the cradle set.

2. Through the tolerance provided by the sectional bolt, the connector is prevented from getting a serious bend due to an inappropriate plugging or unplugging of the PDA module by a user. Hence, reliability of connector alignment is greatly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A self-alignment structure for a cradle set comprising a circuit board and a connector mounted on the circuit board, the self-alignment structure comprising:
a base plate having at least a threaded hole therein; and
at least a sectional bolt having a rod body with one end of the rod body attached to a threaded section and the other end of the rod body attached to a cap piece of the sectional bolt, wherein the rod body has a diameter greater than the threaded section, and the threaded section of the sectional bolt passes through the circuit board and screws into the threaded hole in the base plate such that the bottom surface of the rod body is in contact with the surface of the base plate and the bottom surface of the cap piece faces the circuit board, wherein the rod body has a length larger than a thickness of the circuit board.

2. The self-alignment structure of claim 1 furthermore comprising an elastic body incorporated between the circuit board and the cap piece of the sectional bolt.

3. The self-alignment structure of claim 2, wherein the elastic body comprises a spring washer with a through hole for accommodating the rod body such that the two surfaces of the spring washer are in contact with the circuit board and the cap piece of the sectional bolt respectively.

4. The self-alignment structure of claim 2, wherein the elastic body comprises a rubber washer with a through hole for accommodating the rod body such that the two surfaces of the rubber washer are in contact with the circuit board and the cap piece of the sectional bolt respectively.

5. The self-alignment structure of claim 2, wherein the elastic body comprises a rubber washer with a through hole for accommodating the rod body and a spacer attached to the surface of the rubber washer such that the spacer is positioned within a gap between the circuit board and the sectional bolt.

6. The self-alignment structure of claim 2, wherein the elastic body comprises a rubber washer with a through hole for accommodating the rod body, an outer groove ring on a side surface of the rubber washer such that the interior surfaces of the outer groove ring are in contact with two surfaces of the circuit board and a spacer between the through hole and the outer groove ring of the rubber washer that fills the space between the circuit board and the sectional bolt.

7. The self-alignment structure of claim 2, wherein the elastic body comprises a compression spring with two ends in contact with the circuit board and the sectional bolt respectively.

8. The self-alignment structure of claim 2, wherein the material constituting the elastic body is selected from a group consisting of silicone, rubber and resin.

9. A connector mounting structure for a cradle set having a connector therein, the connector mounting structure at least comprising:
a base plate having a threaded hole therein;
a circuit board positioned over the base plate, wherein the connector is attached to the circuit board positioned and the circuit board has a through hole that corresponds with the threaded hole in the base plate; and
a sectional bolt with a rod body such that one end of the rod body is attached to a threaded section and the other end of the rod body is attached to a cap piece, wherein the threaded section of the bolt passes through the through hole in the circuit board and screws into the threaded hole in the base plate to tighten the circuit board and a bottom surface of the cap piece faces a surface of the circuit board;
at least a spacer ring positioned within the through hole with the edge of the space ring in contact with the bottom surface of the cap piece and the base plate respectively; and
an elastic body inserted into a space between the circuit board and the cap piece.

10. The connector mounting structure of claim 9, wherein the elastic body comprises a spring washer with a through hole for accommodating the rod body and the spacer ring such that the two surfaces of the spring washer are in contact with the circuit board and the cap piece.

11. The connector mounting structure of claim 9, wherein the elastic body comprises a rubber washer with a through hole for accommodating the rod body and the spacer ring such that the two surfaces of the rubber washer are in contact with the circuit board and the cap piece.

12. The connector mounting structure of claim 9, wherein the elastic body comprises a compression spring and the compression spring is set up with one end in contact with the circuit board and the other end in contact with the cap piece of the bolt.

13. The connector mounting structure of claim 9, wherein the material constituting the elastic body is selected from a group consisting of silicone, rubber and resin.

14. A cradle set for mounting a handheld device, comprising:
a groove for accommodating a lower portion of the handheld device;
a base plate;
a printed circuit board mounted on the base plate;
a connector mounted on the printed circuit board and projecting in the groove for electrically connecting with the handle device; and
a sectional bolt fastening the printed circuit board and the base plate together, wherein the sectional bolt has a threaded portion threadedly engaging with the base plate, a rod body having a diameter large than that of the threaded portion and extending in the printed circuit board, and a cap piece having a diameter larger than that of the rod body and located over the printed circuit board, and wherein the rod body has a length larger than a thickness of the printed circuit board.

15. The cradle set in accordance with claim 14, wherein an elastic body is mounted between the cap piece of the sectional bolt and the printed circuit board.

16. The cradle set in accordance with claim 15, wherein the elastic body is made of rubber.

17. The cradle set in accordance with claim 15, wherein the elastic body is a spring.
